(19) United States
(12) Patent Application Publication
(10) Pub. No.: US 2025/0343641 A1
(43) Pub. Date: Nov. 6, 2025

(54) METHOD AND APPARATUS OF UPLINK TRANSMISSION

(71) Applicant: LENOVO (BEIJING) LIMITED, Beijing (CN)

(72) Inventors: Chenxi Zhu, Fairfax, VA (US); Bingchao Liu, Beijing (CN); Lingling Xiao, Beijing (CN); Yi Zhang, Beijing (CN); Wei Ling, Beijing (CN)

(21) Appl. No.: 18/866,283

(22) PCT Filed: May 17, 2022
(86) PCT No.: PCT/CN2022/093327

§ 371 Date: Nov. 15, 2024

(51) Int. Cl. H04L 5/00; H04W 72/0453; H04W 72/21

(52) U.S. Cl. CPC H04L 5/001; H04L 5/0091; H04W 72/0453; H04W 72/21

(57) ABSTRACT

Embodiments of the present application are related to a method and apparatus of uplink transmission. An embodiment of the present application provides a user equipment (UE), including: a transceiver; and a processor coupled to the transceiver, wherein the processor is configured to, with the transceiver: receive a radio resource control (RRC) configuration indicating a plurality of associated bandwidth parts (BWP) sof at least one cell: receive a signal at least indicating a waveform for physical uplink shared channel (PUSCH) in at least one BWP of the plurality of associated BWPs; and apply the waveform for PUSCH transmission in the plurality of associated BWPs in the case that the waveform is applicable for PUSCH.

### TECHNICAL FIELD

Embodiments of the present disclosure are related to wireless communication technology, and more particularly, related to a method and apparatus of uplink (UL) transmission, e.g., physical uplink shared channel (PUSCH) transmission.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In an exemplary wireless communication system, carrier aggregation (CA) technology can be used. The CA technology can aggregate multiple component carriers (CCs) together to achieve a wider transmission bandwidth, e.g., up to 100 MHz, which will effectively improve UL and downlink (DL) transmission rates. A user equipment (UE) may transmit data signals to a base station (BS) via a PUSCH in a bandwidth part (BWP) of a carrier of the aggregated carriers with a waveform for PUSCH.

Various waveforms, including a discrete Fourier transform-spread orthogonal frequency division multiplexing (DFT-s-OFDM) waveform and a cyclic prefix orthogonal frequency division multiplexing (CP-OFDM) waveform, may be applied to PUSCH for at least one BWP of at least one carrier (or cell). Different waveforms may be advantageous in different scenarios. However, how to dynamically switch between different waveforms in more than one carrier, e.g., in a CA scenario with low signal overhead and low delay has not been solved yet.

### SUMMARY

Embodiments of the present disclosure at least provide a technical solution of simultaneously switching different types of PUSCH waveforms, e.g., between CP-OFDM and DFT-s-OFDM in more than one carrier, which can reduce signaling overhead and time-consuming etc.

According to some embodiments of the present disclosure, a UE may include: a transceiver; and a processor coupled to the transceiver, wherein the processor is configured to, with the transceiver: receive a radio resource control (RRC) configuration indicating a plurality of associated BWPs of at least one cell; receive a signal at least indicating a waveform for PUSCH in at least one BWP of the plurality of associated BWPs; and apply the waveform for PUSCH transmission in the plurality of associated BWPs in the case that the waveform is applicable for PUSCH.

In some embodiments of the present disclosure, the waveform is DFT-s-OFDM or CP-OFDM.

In some embodiments of the present disclosure, the signal is a medium access control (MAC) control element (CE), and the plurality of associated BWPs are all BWPs of a cell indicated in the RRC configuration or all BWPs of a list of cells indicated in the RRC configuration.

In some embodiments of the present disclosure, the MAC CE indicates one or more waveforms to be applied for PUSCH for one or more cells, each waveform being signaled for individual cell.

In some embodiments of the present disclosure, the MAC CE indicates the one or more waveforms to be applied for PUSCH for the one or more cells by a bitmap.

In some embodiments of the present disclosure, the plurality of associated BWPs is associated in the case of a parameter of common TransformPrecoder being enabled in the RRC configuration.

In some embodiments of the present disclosure, the RRC configuration indicates one or more lists of cells including the list of cells, different lists of cells indicate different cells, and all cells within each list of the one or more lists of cells share a same waveform.

In some embodiments of the present disclosure, the signal is a MAC CE or downlink control information (DCI) in a physical downlink control channel (PDCCH).

In some embodiments of the present disclosure, the plurality of associated BWPs are BWPs with a same BWP index in a list of cells indicated in the RRC configuration.

In some embodiments of the present disclosure, the plurality of associated BWPs include a reference BWP of a reference cell and at least one remaining BWP associated with the reference BWP, and the at least one BWP indicated in the signal is the reference BWP.

In some embodiments of the present disclosure, the reference BWP is indicated by a field of reference BWP, and the reference cell is indicated by a field of reference serving cell or being the same as a cell in a BWP uplink dedicated information element (IE) of the RRC configuration.

In some embodiments of the present disclosure, an absent field within a PUSCH configuration for a BWP of the at least one remaining BWP is referred to that for the reference BWP.

According to some embodiments of the present disclosure, a BS may include: a transceiver; and a processor coupled to the transceiver, wherein the processor is configured to, with the transceiver: transmit a RRC configuration indicating a plurality of associated BWP of at least one cell; transmit a signal at least indicating a waveform for PUSCH in at least one BWP of the plurality of associated BWPs; and apply the waveform for PUSCH reception in the plurality of associated BWPs in the case that the waveform is applicable for PUSCH.

According to some other embodiments of the present disclosure, a method performed by a UE may include: receiving a RRC configuration indicating a plurality of associated BWP of at least one cell; receiving a signal at least indicating a waveform for PUSCH in at least one BWP of the plurality of associated BWPs; and apply the waveform for PUSCH transmission in the plurality of associated BWPs in the case that the waveform is applicable for PUSCH.

According to some yet other embodiments of the present disclosure, a method performed by a BS may include: transmitting a RRC configuration indicating a plurality of associated BWP of at least one cell; transmitting a signal at least indicating a waveform for PUSCH in at least one BWP of the plurality of associated BWPs; and apply the waveform for PUSCH reception in the plurality of associated BWPs in the case that the waveform is applicable for PUSCH.

Given the above, embodiments of the present application provide a new mechanism to signal to a UE the UL waveform for PUSCH to simultaneously update the waveform of multiple BWPs of at least one cell or carrier in low signal overhead and low delay, and accordingly improve system performance and user experience.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a flow chart illustrating an exemplary method of switching PUSCH waveform according to some embodiments of the present disclosure.

FIG. 2 illustrates some fields of an exemplary MAC CE in Format 1 according to some embodiments of the present disclosure.

FIG. 3 illustrates some fields of an exemplary MAC CE in Format 2 according to some other embodiments of the present disclosure.

FIG. 4 illustrates an exemplary procedure of UL transmission according to some embodiments of the present disclosure.

FIG. 5 illustrates a simplified block diagram of an exemplary apparatus of uplink transmission according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP LTE Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

According to some embodiments of the present disclosure, a UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE includes wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art. The UE may communicate with a BS via UL communication signals. A BS may be distributed over a geographic region. In certain embodiments of the present disclosure, the BS may also be referred to as an access point, an access terminal, a base, a base unit, a macro cell, a Node-B, an evolved Node B (eNB), a gNB, a Home Node-B, a relay node, or a device, or described using other terminology used in the art. The BS is generally a part of a radio access network that may include one or more controllers communicably coupled to one or more corresponding BSs. The BS may communicate with the UE via DL communication signals.

The BS and the UE are within a wireless communication system (or a network) which may be compatible with any type of network that is capable of sending and receiving wireless communication signals. For example, the wireless communication system is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks. It is contemplated that there may be one or more UEs in the wireless communication system which are the same or similar to the aforementioned UE.

In some embodiments of the present disclosure, the wireless communication system is compatible with 5G NR of the 3GPP protocol. For example, the BS may transmit data using an OFDM modulation scheme on the DL and the UE may transmit data on the UL using a DFT-S-OFDM or CP-OFDM scheme. However, the wireless communication system may implement some other open or proprietary communication protocols, for example, WiMAX, among other protocols.

In some embodiments of the present disclosure, the BS and UE may communicate using other communication protocols, such as the IEEE 802.11 family of wireless communication protocols. Further, in some embodiments of the present disclosure, the BS and the UE may communicate over licensed spectrums, whereas in some other embodiments, the BS and UE may communicate over unlicensed spectrums. Embodiments of the present disclosure are not intended to be limited to the implementation of any particular wireless communication system architecture or protocol.

Regarding PUSCH, there are various settings for a PUSCH mode. For example, the settings for the PUSCH mode include setting the waveform for the PUSCH. Various waveforms, including but not be limited to DFT-s-OFDM waveform and CP-OFDM waveform, are supported in a PUSCH(s) and may have their respective characteristics and corresponding advantages in different scenarios. For example, for a PUSCH with a DFT-s-OFDM waveform (e.g., the parameter transformPrecoder is enabled as specified in 3GPP standard), only one layer is supported; while for a PUSCH with a CP-OFDM waveform (e.g., the parameter transformPrecoder is disabled as specified in 3GPP standard documents), up to four layers can be supported. Moreover, compared with the CP-OFDM waveform, the peak to average power ratio (PAPR) of the DFT-s-OFDM waveform is lower, and the efficiency of the power amplifier in UE is higher. Therefore, when a UE is in different environments or scenarios, or when the UE performs different applications, the waveform of the PUSCH may be changed (or switched or updated) dynamically.

The PUSCH settings may be configured or changed by a RRC configuration, e.g., PUSCH-Config transmitted from a BS or a network via RRC signaling, which is used to configure the UE specific PUSCH parameters applicable to a particular BWP. The BS may semi-statically configure or change a PUSCH mode by higher layer (e.g., a layer higher than a physical layer) signaling. e.g., radio resource control (RRC) signaling. For example, the BS may update a waveform for PUSCH for a BWP of a carrier via a parameter (item) named transformPrecoder within the PUSCH-Config; if transformPrecoder is set to 1 (i.e., being enabled), DFT-s-OFDM waveform is used for PUSCH; and if transformPrecoder is set to 0 (i.e., being disabled), CP-OFDM waveform is used for PUSCH. When the BS decides to change the waveform of the PUSCH for a BWP of a cell due to e.g., UE movement from a cell edge to a cell center or from the cell center to the cell edge, the BS will transmit a whole PUSCH-Config with only the field transformPrecoder being updated via RRC signaling. As a PUSCH-Config contains much information or a lot of fields, in some cases, it spends 10 to 16 ms for the new waveform in the new PUSCH-Config becomes applicable after reception of the PUSCH-Config by the UE via a RRC signaling. This delay is long for a UE moving towards the cell edge or the cell center, and thus may cause service disruption.

Furthermore, it is time-consuming to reconfigure or update the waveform using an RRC message each time. The latency of RRC reconfiguration may not support the dynamic switching required in the case, for example, when the UE keeps moving between the cell edge and the cell center.

In addition, if the BS needs to update or switch the waveform for PUSCH for one or more BWPs of at least one cell (or carrier), it needs to transmit one or more PUSCH configurations, e.g., in some scenarios where CA technology is supported. If only one waveform for PUSCH in a single BWP of a cell is changed each time, it will cause very high signaling overhead for changing the waveforms for PUSCH in multiple BWPs of a cell or multiple cells.

Embodiments of the present disclosure provide a technical solution of UL transmission, which can switch waveform(s) in more than one BWP of at least one cell simultaneously via a signal (or signaling), e.g., MAC CE or DCI so as to switch waveform with low time consuming and low signaling overhead. In particular, embodiments of the present disclosure address the issue of UL waveform switching in the carrier aggregation, e.g., how to switch waveform in more than one carrier.

FIG. 1 is a flow chart illustrating an exemplary method 100 of switching PUSCH waveform according to some embodiments of the present disclosure. The method can be performed in a UE or the like.

As shown in FIG. 1, a gNB may configure a plurality of associated BWPs, and transmit the plurality of associated BWPs to the UE, e.g., by a RRC configuration. In operation (or step) 110, the UE will receive the RRC configuration, e.g., from the gNB, which indicates the plurality of associated BWPs of at least one cell. The plurality of associated BWPs can be associated in various manners. For example, the plurality of associated BWPs are all BWPs of a cell indicated in the RRC configuration or all BWPs of a list of cells indicated in the RRC configuration. A parameter of common TransformPrecoder or the like may be provided in the RRC configuration, which is set “enabled” to associate the plurality of BWPs. In another example, the plurality of associated BWPs are BWPs with the same BWP index of cells in a list of cells indicated in the RRC configuration. In yet another example, the plurality of associated BWPs may include a reference BWP, and all the remaining BWP(s) is associated with the BWP. The RRC configuration may be various RRC IE, e.g., UplinkConfig IE or CellGroupConfig or BWP-UplinkDedicated etc.

When the gNB decides to make a waveform switching for plurality of associated BWPs, it may transmit a signal, e.g., a MAC CE or DCI (hereafter, a DCI refers to DCI in a PDCCH) to the UE to change the waveform for the plurality of associated BWPs. The signal may indicate the waveform for one or more of the plurality of associated BWPs. In operation 120, the UE will receive the signal, e.g., from the gNB, which at least indicating a waveform, e.g., DFT-s-OFDM or CP-OFDM for PUSCH in at least one BWP of the plurality of associated BWPs. In response to the signal, the UE will apply the waveform for PUSCH transmission in the plurality of associated BWPs in the case that the waveform is applicable for PUSCH in operation 130. That is, in the case that there is PUSCH transmission(s) in any BWP of the plurality of associated BWPs and the indicated waveform is applicable, the UE will transmit the PUSCH with the indicated waveform. Accordingly, the gNB will receive the PUSCH with the indicated waveform in the plurality of associated BWPs. That is, the gNB will apply the waveform for PUSCH reception in the plurality of associated BWPs in the case that the waveform is applicable for PUSCH.

By such a novel mechanism, the gNB can dynamically switch the PUSCH waveform for multiple BWPs of at least one cell by a single signal, which can greatly reduce time consuming and signaling overhead for waveform switching.

In some embodiments of the present application, whether or when the waveform indicated in the received signal for a BWP, e.g., an activated BWP, is applicable depends upon the time when the PUSCH is transmitted. Taking the MAC CE as an example, the waveform indicated in the received signal is applicable after a duration from the successful reception of the MAC CE, from the transmission of the acknowledgement (ACK) to the BS in response to the successful reception of the signal. In other words, if the PUSCH is transmitted after the duration, the waveform indicate in the MAC CE will be applied for the PUSCH in the activated BWP; otherwise, the waveform indicated in the MAC CE will not be applied for the PUSCH in the activated BWP before being applicable. In some embodiments, the duration is kNₛₗₒₜ^{subframe,μ}, wherein, μ is SCS of a carrier where the ACK in response to the reception of the MAC CE is sent to the BS, k is a constant, for example, 3. In some embodiments, k is signaled to the BS or the network by the UE as part of its capability.

In some embodiments of the present application, the PUSCH is scheduled by a DCI, and the time when the PUSCH is transmitted is determined by the DCI (e.g., the time domain resource assignment field within the DCI). Whether the waveform indicated in the signal is applicable for the scheduled PUSCH in the activated BWP is determined based on the time when the DCI scheduling the PUSCH is received. Still taking the MAC CE as an example, the UE will transmit PUSCH in the activated BWP with the waveform indicated in the signal if the DCI scheduling the PUSCH is received after a duration from the successful reception of the signal from the transmission of the ACK to the BS in response to the successful reception of the MAC CE. In some embodiments of the present application, the duration is kNₛₗₒₜ^{subframe,μ}, wherein, μ is SCS of a carrier where the ACK is sent, k is a constant, for example, 3. k can be signaled to the BS or the network by the UE as part of its capability.

Exemplary formats of MAC CE are also provided in some embodiments of the present application, wherein one or more waveforms to be applied for PUSCH for all BWPS of one or more cells is indicated in the MAC CE, each waveform being signaled for individual cell.

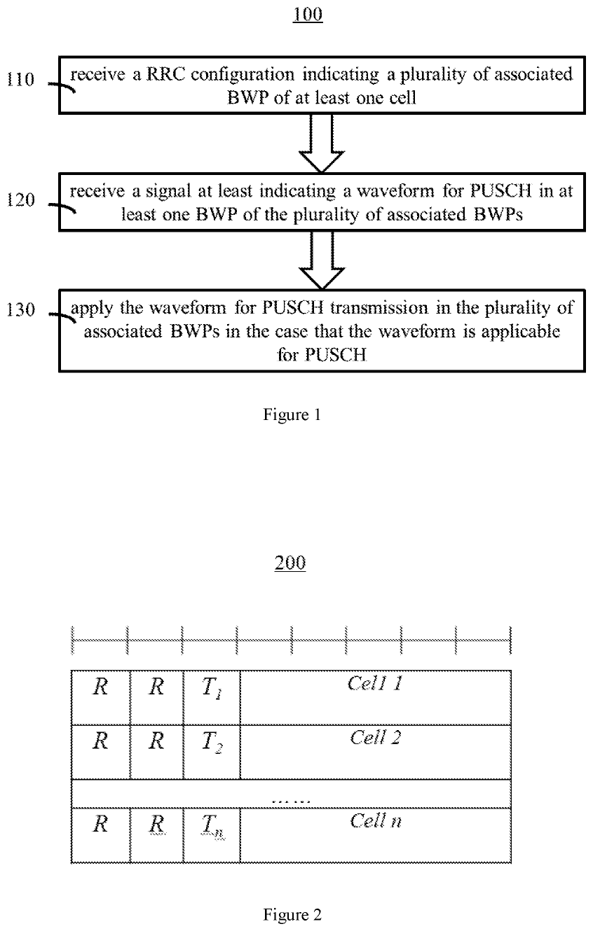

FIG. 2 illustrates some fields of an exemplary MAC CE 200 in Format 1 according to some embodiments of the present disclosure, where the same waveform for PUSCH is applied to all BWPs of a cell.

Referring to FIG. 2, there are n field(s) in the MAC CE 200 for waveform switching, wherein n is a positive integer. For each filed, Tₙ. e.g., with one bit is used to indicate the waveform, i.e., represent the status of TranformPrecoder for PUSCH for each cell; each cell ID, e.g., with 5 bits, indicates each cell; and the rest bits, e.g., two “R” are reserved. Persons skilled in the art should well know that the specific bit number illustrated herein is only for illustrating the format of the MAC CE and should not be deemed as the limitation to the scope of the present disclosure. Tₙ indicated in the MAC CE 200 may be set to 0 or 1. If Tₙ is set to 1, waveform DFT-s-OFDM for PUSCH will be applied to all BWPs of cell n, and if Tₙ is set to 0, waveform CP-OFDM will be applied to all BWPs of cell n, vice versa.

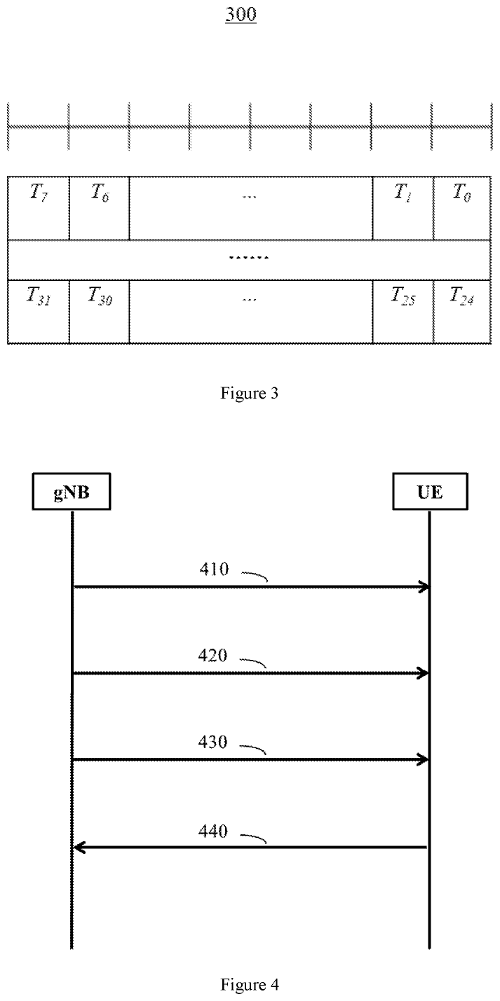

FIG. 3 illustrates another exemplary MAC CE 300 in Format 2 according to some other embodiments of the present disclosure, where the same waveform for PUSCH is also applied to all BWPs of a cell.

Referring to FIG. 3, the MAC CE 300 indicates one or more waveforms to be applied for PUSCH for one or more cells by a bitmap, wherein the waveforms indicated by T₀, T₁, . . . . T₃₀, and T₃₁ correspond to cell 0, cell 1 . . . cell 30, and cell 31 respectively.

Specifically, To indicates the waveform for all BWPs of cell 0, T₁ indicates the waveform for all BWPs of cell 1 . . . and T₃₁ indicates the waveform for all BWPs of cell 31. Each of T₀, T₁, . . . . T₃₀, T₃₁ may be set to 0 or 1. For example, If T₀ is set to 1, waveform DFT-s-OFDM for PUSCH will be applied to all BWPs of cell 0; and if T₀ is set to 0, waveform CP-OFDM will be applied to all BWPs of cell 0. Persons skilled in the art should well know that the specific cell number illustrated herein is only for illustrating the format of the MAC CE, and should not be deemed as the limitation to the scope of the present disclosure.

When a waveform, e.g., Tₙ indicated in MAC CE 200 or in the MAC CE 300 indicates the same waveform as currently used for PUSCH in any BWP(s) in cell n, the currently used waveform will be continued to be used in PUSCH in the BWP(s) and there is waveform switching in all other BWP(s) of cell n. If a waveform, e.g., Tₙ indicated in MAC CE 200 or indicated in the MAC CE 300 indicates a different waveform from the currently used waveform in all BWP(s) of cell n, the waveform indicated in MAC CE 200 or MAC CE 300 will be used for PUSCH in all the BWPs of cell n when the indicated waveform is applicable. For example, if Tₙ is 1, and the currently used waveform for PUSCH in all BWPs of cell n is DFT-s-OFDM, then DFT-s-OFDM is continued to be used for PUSCH on all the BWPs of cell n. If Tₙ is 1, and the currently used waveform for PUSCH in all BWPs of cell n is CP-OFDM, then DFT-s-OFDM will be applied for PUSCH on all the BWPs of cell n when it is applicable.

More detailed embodiments of the present application will be further illustrated hereafter in view of different RRC configurations for indicating the plurality of associated BWPs. Persons skilled in the art should well know that, although some embodiments are only illustrated in the UE side, it is contemplated that the corresponding BS side will performs consistent operations, vice versa.

UplinkConfig information element

| | |
|---|---|
| UplinkConfig ::= | SEQUENCE { |

| | |
|---|---|
| initialUplinkBWP | BWP-UplinkDedicated |

OPTIONAL, -- Need M

| | |
|---|---|
| uplinkBWP-ToReleaseList | SEQUENCE (SIZE (1..maxNrofBWPs)) OF BWP-Id |

OPTIONAL, -- Need N

| | |
|---|---|
| uplinkBWP-ToAddModList | SEQUENCE (SIZE (1..maxWrofBWPs)) OF BWP-Uplink |

OPTIONAL, -- Need N

| | |
|---|---|
| firstActiveUplinkBWP-Id | BWP-Id |

OPTIONAL, -- Cond SyncAndCellAdd

| | |
|---|---|
| pusch-ServingCellConfig | SetupRelease { PUSCH-ServingCellConfig } |

OPTIONAL, -- Need M

| | |
|---|---|
| carrierSwitching | SetupRelease { SRS-CarrierSwitching } |

```
OPTIONAL, -- Need M
    ...,
    [[
```

| | |
|---|---|
| powerBoostPi2BPSK | BOOLEAN |

OPTIONAL, -- Need M

| | |
|---|---|
| uplinkChannelBW-PerSCS-List | SEQUENCE (SIZE (1..maxSCSs)) OF SCS-SpecificCarrier |

```
OPTIONAL -- Nesd S
    ]],
    [[
```

| | |
|---|---|
| enablePL-RS-UpdateForPUSCH-SRS-116 | ENUMERATED {enabled} |

OPTIONAL, -- Need R

| | |
|---|---|
| enableDefaultBeamPL-ForPUSCH0-0-r16 | ENUMERATED {enabled} |

OPTIONAL, -- Need R

| | |
|---|---|
| enableDefaultBeamPL-For PUCCH-r16 | ENUMERATED {enabled} |

OPTIONAL, -- Need R

| | |
|---|---|
| enableDefaultBeamPL-ForSRS-r16 | ENUMERATED {enabled} |

OPTIONAL, -- Need R

| | |
|---|---|
| uplinkTxSwitching-r16 | SetupRelease { UplinkTxSwitching-r16 } |

OPTIONAL, -- Need M

| | |
|---|---|
| mpr-PowerBoost-FR2-r16 | ENUMERATED {true} |

OPTIONAL -- Need R

| | |
|---|---|
| commonTransformPrecoder | ENUMERATED {enabled} |

OPTIONAL -- Need R
]]
}

According to some embodiments of the present disclosure, in a RRC configuration, all the BWPs of a carrier or cell or CC need be configured to share the same UL waveform. That is, the plurality of associated BWPs configured by the RRC configuration are all BWPs of the same cell. An exemplary RRC configuration is an UplinkConfig IE shown above or the like. A new parameter of common TransformPrecoder e.g., common TransformPrecoder being enabled is included in the UplinkConfig IE. When one of the BWPs of the same cell is signalled to apply a waveform (e.g., transformPrecoder is set to true or false), the same waveform is applied to all the UE specific BWPs in the same carrier in the same UplinkConfig IE. If the parameter is not configured in the RRC configuration, no common UL waveform is applied to all the BWPs of the carrier.

CellGroupConfig information element

-- ASN1START
-- TAG-CELLGROUPCONFIG-START
-- Configuration of one Cell-Group:

| | |
|---|---|
| CellGroupConfig ::= | SEQUENCE { |

| | |
|---|---|
| cellGroupId | CellGroupId, |
| rlc-BearerToAddModList | SEQUENCE (SIZE(1..maxLC-ID)) OF RLC-BearerConfig |

OPTIONAL, -- Need N

| | |
|---|---|
| rlc-BearerToReleaseList | SEQUENCE (SIZE(1..maxLC-ID)) OF |

| | |
|---|---|
| LogicalChannelIdentity | OPTIONAL, -- Need N |

| | |
|---|---|
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE (1..maxNrofSCells)) OF SCellConfig |

OPTIONAL, -- Need N

| | |
|---|---|
| sCellToReleaseList | SEQUENCE (SIZE (1..maxNrofSCells)) OF SCellIndex |

```
OPTIONAL, -- Need N
  ...,
  [[
```

| | |
|---|---|
| reportUplinkTxDirectCurrent | ENUMERATED {true} |

```
OPTIONAL -- Cond BWP-Reconfig
  ]],
  [[
```

| | |
|---|---|
| bap-Address-r16 | BIT STRING (SIZE (10)) |

OPTIONAL, -- Need M

| | |
|---|---|
| bh-RLC-ChannelToAddModList-r16 | SEQUENCE (SIZE(1..maxBH-RLC-ChannelID-r16)) OF BH- |

| | | |
|---|---|---|
| RLC-ChannelConfig-r16 | OPTIONAL, | -- Need N |

| | |
|---|---|
| bh-RLC-ChannelToReleaseList-r16 | SEQUENCE (SIZE(1..maxBH-RLC-ChannelID-r16)) OF BH- |

| | | |
|---|---|---|
| RLC-ChannelID-r16 | OPTIONAL, | -- Need N |

| | |
|---|---|
| f1c-TransferPath-r16 | ENUMERATED {lte, nr, both} |

OPTIONAL, -- Need M

| | |
|---|---|
| simultaneousTCI-UpdateList1-r16 | SEQUENCE (SIZE (1..maxNrofServingCellsTCI-r16)) OF |

| | | |
|---|---|---|
| ServCellIndex | OPTIONAL, | -- Need R |

| | |
|---|---|
| simultaneousTCI-UpdateList2-r16 | SEQUENCE (SIZE (1..maxNrofServingCellsTCI-r16)) OF |

| | | |
|---|---|---|
| ServCellIndex | OPTIONAL, | -- Need R |

| | |
|---|---|
| simultaneousSpatial-UpdatedList1-r16 | SEQUENCE (SIZE (1..maxNrofServingCellsTCI-r16)) OF |

| | | |
|---|---|---|
| ServCellIndex | OPTIONAL, | -- Need R |

| | |
|---|---|
| simultaneousSpatial-UpdatedList2-r16 | SEQUENCE (SIZE (1..maxNrofServingCellsTCI-r16)) OF |

| | | |
|---|---|---|
| ServCellIndex | OPTIONAL, | -- Need R |

```
  simultaneousTransformPrecoder-UpdateList1-r18 SEQUENCE (SIZE
(1..maxNrofServingCellsTransformPrecoder-r18)) OF ServCellIndex OPTIONAL,
-- Need R
  simultaneousTransformPrecoder-UpdateList2-r18 SEQUENCE (SIZE
(1..maxNrofServingCellsTransformPrecoder-r18)) OF ServCellIndex OPTIONAL,
-- Need R
```

| | |
|---|---|
| uplinkTxSwitchingOption-r16 | ENUMERATED {switchedUL, dualUL} |

OPTIONAL, -- Need R

| | |
|---|---|
| uplinkTxSwitchingPowerBoosting-r16 | ENUMERATED {enabled} |

```
OPTIONAL -- Need R
  ]],
  [[
```

| | |
|---|---|
| reportUplinkTxDirectCurrentTwoCarrier-r16 | ENUMERATED {true} |

OPTIONAL -- Need N
]]
}
......
-- TAG-CELLGROUPCONFIG-STOP
-- ASN1STOP

According to some other embodiments of the present disclosure, the plurality of associated BWPs are all BWPs of more than one cell (or carrier or CC), e.g., a list of cells indicated in the RRC configuration. For example, to further reduce the signaling overhead and delay, the UL waveform can be set for all the BWPs of multiple carriers that are associated with each other, e.g., carriers within a cell list (or carrier list, or list of cells, or list of carriers). The list of carriers will be configured to share or use the same UL waveform. One or more such lists of cells can be defined in RRC, e.g., in CellGroupConfig IE as shown above or the like, each including one or more carriers. In the case of multiple cell lists are defined, different lists include different carriers, that is, one cell is included in only one cell list and should not be included in two or more cell lists.

The above exemplary CellGroupConfig IE provides two cell lists: a first cell list, e.g., simultaneousULWaveform-UpdateList1-r18 and a second cell list, e.g., simultaneous ULWaveform-UpdateList2-r18. The same waveform for PUSCH will be applied to all BWPs of all cells in each cell list respectively. When a signaling, e.g., a MAC CE indicates a waveform for any CC or any BWP of the CC in a cell list, the waveform will be applied to all BWPs of all cells in the cell list. The waveform applied to different cell lists, e.g., the first cell list simultaneous ULWaveform-UpdateList1-r18 and the second cell list simultaneous ULWaveform-UpdateList2-r18 may be the same or different.

According to some other embodiments of the present disclosure, the plurality of associated BWPs are BWPs with the same BWP index of multiple cells indicated in the RRC configuration. The multiple cells may also be configured in a list of cells. That is, BWPs with the same BWP index of all the multiple cells will share the same waveform, and the same waveform will be applied to the BWPs with the same BWP index of all the cells. Thus, in a CA scenario, the UL BWPs with the same index (for example, BWP #1) in different CCs of a CC list will be associated and apply the same UL waveform to all these BWPs in these CCs. For example, two lists of CCs can be configured in RRC, e.g., ULsharedWaveformList1 and ULsharedWaveformList2. When a UE receives a MAC CE signalling the UL waveform for BWP1 of CC1, and CC1 is included in the list ULsharedWaveformList1, the same UL waveform will be applied to all BWP1 of the CCs in the list ULsharedWaveformList1.

More specifically, an exemplary RRC configuration may define two CC list, e.g., a first list, ULsharedWaveformList1={cc11, cc12, . . . } and a second list, ULsharedWaveformList1={cc21, cc22, . . . }. All BWP1 of cc11, cc12, . . . share the same UL waveform, all BWP2 of cc11, cc12, . . . share the same UL waveform, and so on. For the CCs in ULsharedWaveformList1, their UL waveforms in BWP1, BWP2, BWP3, BWP4 can be signalled separately. Similarly, all BWP1 of cc21, cc22, . . . share the same UL waveform, all BWP2 of cc21, cc22, . . . share the same UL waveform, and so on. For the CCs in ULsharedWaveformList1 or ULsharedWaveformList2, their UL waveforms in BWP1, BWP2, BWP3, BWP4 can be signalled separately.

According to some yet other embodiments of the present disclosure, a reference BWP of a reference cell (or CC) is proposed. The waveform for more than one BWPs is indicated to the reference BWP of a reference cell, and apply the same waveform to other BWPs associated with the reference BWP. That is, the plurality of associated BWPs include a reference BWP of a reference cell and at least one remaining BWP associated with the reference BWP. The signal, e.g., the MAC CE or DCI will indicate the waveform for the reference BWP of the reference cell. Then, the remaining BWP(s) will follow the waveform indicated to the reference BWP. When the UE receives the signal indicating a waveform for PUSCH to be applied to the reference BWP, the UE will apply the indicated waveform for PUSCH to the reference BWP and the at least one remaining BWP associated with the reference BWP, that is, the UE will simultaneously update the waveform for PUSCH for the at least one remaining BWP and the reference BWP.

In some embodiments of the present application, the reference BWP is indicated by a field of reference BWP within the received RRC configuration, and the reference cell is indicated by a field of reference serving cell within the received RRC configuration or being the same as a cell. For example, a reference BWP of a reference CC for sharing the same waveform can be defined in a UE dedicated UL BWP or a PUSCH-Config of a UL BWP. Compared with the legacy technology, a new field referenceBWP-TransformPrecoder and reference ServingCell-TransformPrecoder can be included in the RRC configuration to indicate the reference BWP of a reference CC.

The following is an exemplary BWP-UplinkDedicated IE, wherein the fields referenceBWP-TransformPrecoder and reference ServingCell-TransformPrecoder define the reference BWP and the reference cell respectively. When the UE receives a signal from the BS or the network to change the waveform for PUSCH in the reference BWP of the reference carrier, the waveform for PUSCH of the BWP associated with the reference BWP is also changed. In the case that the field referenceServingCell-TransformPrecoder is absent, the reference BWP and the BWP associated with the reference BWP are assumed to be of the same cell.

BWP-UplinkDedicated Information element

-- ASN1START
-- TAG-BWP-UPLINKDEDICATED-START

| | |
|---|---|
| BWP-UplinkDedicated ::= | SEQUENCE { |
| pucch-Config | SetupRelease { PUCCH-Config } |

OPTIONAL, -- Need M

| | |
|---|---|
| pusch-Config | SetupRelease { PUSCH-Config } |

OPTIONAL, -- Need M

| | |
|---|---|
| configuredGrantConfig | SetupRelease { ConfiguredGrantConfig } |

OPTIONAL, -- Need M

| | |
|---|---|
| srs-Config | SetupRelease { SRS-Config } |

OPTIONAL, -- Need M

| | |
|---|---|
| beamFailureRecoveryConfig | SetupRelease { BeamFailureRecoveryConfig } |

OPTIONAL, -- Cond SpCellOnly
...,

| | |
|---|---|
| referenceBWP-TransformPrecoder | BWP-Id, |

```
OPTIONAL, -- Need R
  referenceServingCell-TransformPrecoderServCellIndex,
OPTIONAL, -- Need R
  [[
```

| | |
|---|---|
| sl-PUCCH-Config-r16 | SetupRelease { PUCCH-Config } |

OPTIONAL, -- Need M

| | |
|---|---|
| cp-ExtensionC2-r16 | INTEGER (1..28) |

OPTIONAL, -- Need R

| | |
|---|---|
| cp-ExtensionC3-r16 | INTEGER (1..28) |

OPTIONAL, -- Need R

| | |
|---|---|
| useInterlacePUCCH-PUSCH-r16 | ENUMERATED {enabled} |

OPTIONAL, -- Need R

| | |
|---|---|
| pucch-ConfigurationList-r16 | SetupRelease { PUCCH-ConfigurationList-r16 } |

OPTIONAL, -- Need M

| | |
|---|---|
| lbt-FailureRecoveryConfig-r16 | SetupRelease { LBT-FailureRecoveryConfig-r16 } |

OPTIONAL, -- Need M

| | |
|---|---|
| configuredGrantConfigToAddModList-r16 | ConfiguredGrantConfigToAddModList-r16 |

OPTIONAL, -- Need N

| | |
|---|---|
| configuredGrantConfigToReleaseList-r16 | ConfiguredGrantConfigToReleaseList-r16 |

OPTIONAL, -- Need N
configuredGrantConfigType2DeactivationStateList-r16

| | |
|---|---|
| ConfiguredGrantConfigType2DeactivationStateList-r16 | OPTIONAL -- Need R |

]]
}
......
-- TAG-BWP-UPLINKDEDICATED-STOP
-- ASN1STOP

The following is an exemplary PUSCH-Config indicating the reference BWP and the reference carrier, wherein the fields referenceBWP-TransformPrecoder and referenceServingCell-TransformPrecoder define the reference BWP and the reference cell. The configured PUSCH shares the same UL waveform status as the reference BWP of the reference carrier. When the UE receives a signal from the BS or the network to change the waveform for PUSCH for the reference BWP of the reference cell, the UE will change the waveform for PUSCH for the BWP associated with the RRC configuration as well.

PUSCH-Config information element

-- ASN1START
-- TAG-PUSCH-CONFIG-START

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S|

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH-TimeDomainResourceAllocationList } |

OPTIONAL, -- Need M

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE] |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| referenceBWP-TransformPrecoder | BWP-Id, |

OPTIONAL, -- Need R
referenceServingCell-TransformPrecoderServCellIndex,
OPTIONAL, -- Need R

| | |
|---|---|
| codebookSubset | ENUMERATED {fullyAndPartialAndNonCoherent, |

partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
......
}
......
-- TAG-PUSCH-CONFIG-STOP
-- ASN1STOP

In some scenarios, the reference BWP of the reference CC is to share more than just the TransformPrecoder state. For example, the PUSCH-Config of a BWP associated with the reference BWP may not have all the fields configured. For those fields or parameters not included or configured, or absent in the PUSCH-Config of the BWP associated with the reference BWP, the UE may refer to the PUSCH-Config of the reference BWP for transmission of PUSCH.

For example, for BWP A in cell B, the PUSCH-Config received indicates a reference to BWP C in cell D, i.e., BWP C in cell D is the reference BWP for BWP A in cell B; cell B and cell D may be the same cell or different cells. The PUSCH transmission in BWP A of cell B may be performed by referring to the RRC configuration PUSCH-Config and the dynamically signaled waveform for PUSCH in BWP C of cell D. The reference BWP of the reference cell may be defined by the field referenceBWP and referenceServingCell respectively.

The exemplary RRC configuration for BWP A of cell B is as follows, wherein BWP-Id is the ID of the BWP C, and referenceServingCell is the cell index of cell D:

PUSCH-Config information element

-- ASN1START
-- TAG-PUSCH-CONFIG-START

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetListe | SEQUENCE (SIZE (1..4)) OF INTEGER {1.. |

maxNrofPhysicalResourceBlocks-1}
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH-TimeDomainResourceAllocationList } |

OPTIONAL, -- Need M

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| referenceBWP | BWP-Id, |

OPTIONAL, -- Need R

| | |
|---|---|
| referenceServingCell | ServCellIndex, |

OPTIONAL, -- Need R

| | |
|---|---|
| codebookSubset | ENUMERATED {fullyAndPartialAndNonCoherent, |

partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
......
}
......
-- TAG-PUSCH-CONFIG-STOP

FIG. 4 illustrates an exemplary procedure of UL transmission according to some embodiments of the present disclosure, wherein dynamically switching waveform for PUSCH occurs.

Referring to FIG. 4, a gNB may configure a plurality of associated BWPs of at least one cell, which can be associated in any manner as illustrated above or the like. In step 410, the gNB will indicate the plurality of associated BWPs to the UE, e.g., by a RRC configuration. Accordingly, the UE will receive the RRC configuration. The RRC configuration may be various RRC IEs as illustrated above or the like, e.g., UplinkConfig IE or CellGroupConfig or BWP-UplinkDedicated etc.

In addition, the gNB may semi-statically configure a waveform for PUSCH in each of the plurality of associated BWPs (hereafter, referred to as a default waveform) by higher layer signaling. e.g., RRC signaling. PUSCHs in different BWPs may be configured with the same or different waveforms. A PUSCH may be dynamically scheduled by a UL grant in a DCI, or may be transmitted based on a CG such as CG Type 1 or CG type 2 as specified in 3GPP standard documents. The CG Type 1 based PUSCH may refer to that: a PUSCH is semi-statically configured to operate in response to the reception of a higher layer parameter (e.g., the parameter configuredGrantConfig including rrc-ConfiguredUplinkGrant as specified in 3GPP standard documents) without the detection of a UL grant in a DCI. The CG Type 2 based PUSCH may refer to that: a PUSCH is semi-persistently scheduled by a UL grant in a valid activation DCI after the reception of a higher layer parameter (e.g., the parameter configuredGrantConfig not including rrc-ConfiguredUplinkGrant as specified in 3GPP standard documents).

However, switching between different waveforms by higher layer signaling is relatively slow. In some scenarios, the gNB may decide to make dynamically waveform switching when the UE needs to frequently transition between different PUSCH transmission modes. For example when the UE moves from cell-center to cell-edge and becomes limited by its transmission power and the gNB needs to ask the UE to transmit with DFT-s-OFDM instead of CP-OFDM waveform. The gNB will transmit a signal indicating the waveform for one or more of the plurality of associated BWPs in step 420 to the UE to switch waveform. The signal may be a MAC CE, e.g., a MAC CE with Format 1 or Format 2 as illustrated above, or is a DCI.

After the signal received in step 420 is applicable, the UE will apply the indicated waveform to PUSCH transmission in the plurality of associated BWPs, that is, the default waveform will be switched to the indicated waveform. In some scenarios, the default waveform may have been dynamically switched, and the indicated waveform will replace the previously switched waveform. Although, the default waveform in some BWP(s) may be the same as the indicated waveform in some scenarios, dynamically waveform switching should also be deemed achieved in such BWP(s).

For example, in some embodiments of the present disclosure, the plurality of associated BWPs indicated in the RRC configuration are all BWPs of a cell, e.g., all BWPs of cell A, and the signal, e.g., a MAC CE or DCI indicates a waveform for a BWP of the cell, e.g., BWP #1 of cell A. Based on the signal, the UE will apply the indicated waveform for PUSCH to all BWPs of the cell, e.g., to all BWPs of cell A. In the case that the cell is in a list of cells, e.g., BWP #1 of cell A of cell list #1, the UE will apply the indicated waveform for PUSCH to all BWPs of all cells in the list of cells, e.g., to all BWPs of all cells in cell list #1.

In some other embodiments of the present disclosure, the plurality of associated BWPs are BWPs with the same BWP index of the cells in a list of cells, e.g., BWP #1 of cells in cell list #1, and the signal, e.g., a MAC CE or DCI indicates a waveform for a BWP with an index of a cell in the list of cells, e.g., BWP #1 of cell A of cell list #1. Based on the signal, the UE will apply the indicated waveform for PUSCH to all BWPs having the same index as the indicated BWP(s) in the list of cells, e.g., to BWP #1 of all cells in cell list #1. Such a mechanism allows different BWPs in the same cell to be configured with the same or different waveforms.

In some yet other embodiments of the present disclosure, the RRC configuration indicates a reference BWP of a reference cell, e.g., BWP #1 of cell A and at least one BWP associated with the reference BWP, e.g. BWP #2 of cell B. In the case that the signal, e.g., a MAC CE or DCI indicates a waveform for the reference BWP, e.g., BWP #1 of cell A, the UE will apply the indicated waveform for PUSCH to the reference BWP and the at least one BWP associated with the reference BWP, e.g., to BWP #1 of cell A and BWP #2 of cell B. If the RRC configuration does not indicate the reference cell where the reference BWP locates, the reference cell and the at least one BWP associated with the reference BWP are in the same cell, e.g., all in cell A. Such a mechanism also allows different BWPs in the same cell to be configured with the same or different waveforms.

A PUSCH in a BWP of the plurality of associated BWPs may be activated or scheduled in step 430 after the signal is applicable in the UE. For example, a PUSCH is activated or scheduled in an activated BWP, e.g., BWP #2 of cell B, which is associated with BWP #1 of cell A according to the RRC configuration, and the signal, e.g., MAC CE or DCI indicates a waveform for BWP #1 of cell A. Then, in step 440, the UE will transmit the PUSCH to the gNB with the waveform indicated in the signal rather than the default waveform. In the case that one or more field configurations for the PUSCH in BWP #2 of cell B are absent and BWP #1 of cell A is a reference BWP, the absent field(s) in the PUSCH configuration of BWP #2 of cell B can also refer to BWP #1 of cell A besides the waveform.

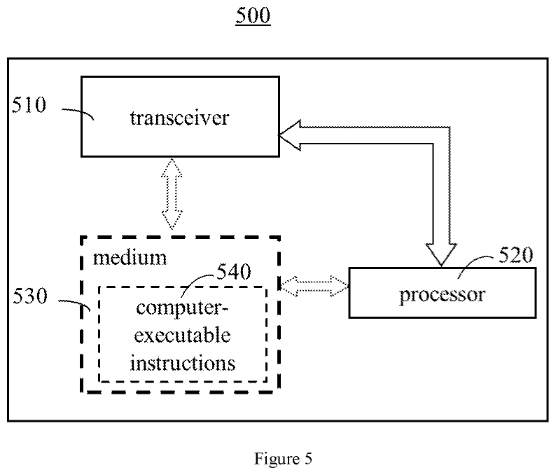

FIG. 5 illustrates a simplified block diagram of an exemplary apparatus 500 according to some embodiments of the present disclosure.

In some embodiments, the apparatus 500 may be or include at least part of a UE which is capable of performing the aforementioned methods of UL transmission, e.g., PUSCH transmission.

In some embodiments, the apparatus 500 may be or include at least part of a BS which is capable of performing the aforementioned methods of UL transmission, e.g., PUSCH transmission.

As shown in FIG. 5, the apparatus 500 may include at least transceiver 510 and processor 520, wherein transceiver 510 may be coupled to processor 520. Furthermore, the apparatus 500 may include non-transitory computer-readable medium 530 with computer-executable instructions 540 stored thereon, wherein non-transitory computer-readable medium 530 may be coupled to processor 520, and computer-executable instructions 540 may be configured to be executable by processor 520. In some embodiments, transceiver 510, non-transitory computer-readable medium 530, and processor 520 may be coupled to each other via one or more local buses.

Although in FIG. 5, elements such as transceiver 510, non-transitory computer-readable medium 530, and processor 520 are described in the singular, the plural is contemplated unless limitation to the singular is explicitly stated. In certain embodiments of the present disclosure, the apparatus 500 may further include other components for actual usage.

In various example embodiments, processor 520 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 520 may also include at least one other circuitry or element not shown in FIG. 5.

In various example embodiments, non-transitory computer-readable medium 530 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 530 may include, but is not limited to, an electric, a magnetic, an optical, an electromagnetic, an infrared, or a semiconductor system, apparatus, or device or any combination of the above.

Further, in various example embodiments, exemplary apparatus 500 may also include at least one other circuitry, element, and interface, for example antenna element, and the like.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE), comprising:
at least one memory; and
at least one processor coupled with the at least one memory and configured to cause the UE to:
receive a radio resource control (RRC) configuration indicating a plurality of associated bandwidth parts (BWP) s of at least one cell;
receive a signal at least indicating a waveform for physical uplink shared channel (PUSCH) in at least one BWP of the plurality of associated BWPs; and
apply the waveform for PUSCH transmission in the plurality of associated BWPs in the case that response to the waveform being applicable for PUSCH.

2. The UE of claim 1, wherein the waveform is discrete Fourier transform-spread orthogonal frequency division multiplexing (DFT-s-OFDM) or cyclic prefix orthogonal frequency division multiplexing (CP-OFDM).

3. The UE of claim 1, wherein the signal is a medium access control (MAC) control element (CE), and the plurality of associated BWPs are all BWPs of a cell indicated in the RRC configuration or all BWPs of a list of cells indicated in the RRC configuration.

4. The UE of claim 3, wherein the MAC CE indicates one or more waveforms to be applied for PUSCH for one or more cells, each waveform being signaled for individual cell.

5. The UE of claim 4, wherein the MAC CE indicates the one or more waveforms to be applied for PUSCH for the one or more cells by a bitmap.

6. The UE of claim 3, wherein the plurality of associated BWPs are associated in the case of response to a parameter of common TransformPrecoder being enabled in the RRC configuration.

7. The UE of claim 3, wherein the RRC configuration indicates one or more lists of cells including the list of cells, different lists of cells indicate different cells, and all cells within each list of the one or more lists of cells share a same waveform.

8. The UE of claim 1, wherein the signal is a medium access control (MAC) control element (CE) or downlink control information (DCI) in a physical downlink control channel.

9. The UE of claim 8, wherein the plurality of associated BWPs are BWPs with a same BWP index in a list of cells indicated in the RRC configuration.

10. The UE of claim 8, wherein the plurality of associated BWPs comprise a reference BWP of a reference cell and at least one remaining BWP associated with the reference BWP, and the at least one BWP indicated in the signal is the reference BWP.

11. The UE of claim 10, wherein the reference BWP is indicated by a field of reference BWP, and the reference cell is indicated by a field of reference serving cell or being the same as a cell in a BWP uplink dedicated information element (IE) of the RRC configuration.

12. The UE of claim 10, wherein an absent field within a PUSCH configuration for a BWP of the at least one remaining BWP is referred to that for the reference BWP.

13. A base station, comprising:
at least one memory; and
at least one processor coupled with the at least one memory and configured to cause the base station to:
transmit a radio resource control (RRC) configuration indicating a plurality of associated bandwidth parts (BWP) of at least one cell;
transmit a signal at least indicating a waveform for physical uplink shared channel (PUSCH) in at least one BWP of the plurality of associated BWPs; and
apply the waveform for PUSCH reception in the plurality of associated BWPs in response to the waveform being applicable for PUSCH.

14. The base station of claim 13, wherein the waveform is discrete Fourier transform-spread orthogonal frequency division multiplexing (DFT-s-OFDM) or cyclic prefix orthogonal frequency division multiplexing (CP-OFDM).

15. A method performed by a user equipment (UE), the method comprising:
receiving a radio resource control (RRC) configuration indicating a plurality of associated bandwidth parts (BWP) of at least one cell;
receiving a signal at least indicating a waveform for physical uplink shared channel (PUSCH) in at least one BWP of the plurality of associated BWPs; and
apply the waveform for PUSCH transmission in the plurality of associated BWPs in response to the waveform being applicable for PUSCH.

16. A processor for wireless communication, comprising:
at least one controller coupled with at least one memory and configured to cause the processor to:
receive a radio resource control (RRC) configuration indicating a plurality of associated bandwidth parts (BWP) s of at least one cell;
receive a signal at least indicating a waveform for physical uplink shared channel (PUSCH) in at least one BWP of the plurality of associated BWPs; and
apply the waveform for PUSCH transmission in the plurality of associated BWPs in response to the waveform being applicable for PUSCH.

17. The processor of claim 16, wherein the waveform is discrete Fourier transform-spread orthogonal frequency division multiplexing (DFT-s-OFDM) or cyclic prefix orthogonal frequency division multiplexing (CP-OFDM).

18. The processor of claim 16, wherein the signal is a medium access control (MAC) control element (CE), and the plurality of associated BWPs are all BWPs of a cell indicated in the RRC configuration or all BWPs of a list of cells indicated in the RRC configuration.

19. The processor of claim 18, wherein the MAC CE indicates one or more waveforms to be applied for PUSCH for one or more cells, each waveform being signaled for individual cell.

20. The processor of claim 19, wherein the MAC CE indicates the one or more waveforms to be applied for PUSCH for the one or more cells by a bitmap.
